(19) United States
(12) Patent Application Publication
(10) Pub. No.: US 2026/0160396 A1
(43) Pub. Date: Jun. 11, 2026

(54) Internal Mailbox Illumination System

(71) Applicant: John M. Coogan, Lansdale, PA (US)

(72) Inventor: John M. Coogan, Lansdale, PA (US)

(21) Appl. No.: 19/408,658

(22) Filed: Dec. 4, 2025

Related U.S. Application Data
(60) Provisional application No. 63/728,878, filed on Dec. 6, 2024.

(51) Int. Cl. F21S 9/03; A47G 29/122; F21V 23/00; F21V 23/02; F21V 31/00; F21W 131/10; F21Y 115/10

(52) U.S. Cl. CPC F21S 9/037; A47G 29/122; F21V 23/005; F21V 23/023; F21V 31/005; F21W 2131/10; F21Y 2115/10

(57) ABSTRACT

An illumination system is disclosed which includes an upper housing having an illumination source and a rechargeable battery pack. The battery pack includes a compartment for one or more rechargeable batteries connected to power the light source. A solar panel and electrical circuit direct solar energy to charge the batteries when there is sufficient light. When ambient light is insufficient, energy from the rechargeable battery powers the light source. The system also features a lower base with an opening for light emission. Lower base is designed to support the upper housing and provide a customizable interface for attachment to external surfaces.

### RELATED APPLICATIONS

The present application claims priority to U.S. Provisional Patent Application number 63/728878, filed on Dec. 6, 2024, the disclosure of which is hereby incorporated by reference in its entirety.

### FIELD OF THE DISCLOSURE

The present disclosure relates generally to illumination systems. More particularly, the present disclosure relates to systems and methods for illuminating outside residential structures.

### BACKGROUND OF THE DISCLOSURE

In residential settings, exterior structures such as mailboxes often lack adequate lighting, which can result in difficulty retrieving and reading mail, particularly in low-light conditions such as at night or in areas with poor natural lighting. Traditionally, mailboxes are constructed without any provisions for lighting features which can result in inconvenience for users who must rely on external lighting sources or portable flashlights to examine the contents of the mailbox. Additionally, the lack of visibility may increase the likelihood of mail being overlooked or damaged as well as increased safety concerns for users while attempting to retrieve mail in darkness. Therefore, there is a need for effective and reliable illumination that integrates with existing mailbox designs.

Previous attempts to address this issue have included the use of external light sources positioned proximal to the mailbox. Some attempts have included the incorporation of motion activated lighting. Unfortunately, these solutions often require separate installation and connection to a residential power source which often means additional energy consumption and ongoing maintenance. Moreover, such illumination sources fail to provide the necessary illumination directly to the mailbox.

### BRIEF SUMMARY OF THE DISCLOSURE

The present disclosure relates to systems and methods for mailbox illumination systems. The interior of a rural or curbside mailbox can be illuminated by a two-piece assembly including an upper housing and a lower base. The two-piece assembly can include a light source, such as a lamp or LED that protrudes through a hole in a top surface of the mailbox. The lamp can be powered by a rechargeable battery pack that is electrically connected to an electronic circuit board. The electronic circuit board can manage the delivery of electrical power from the rechargeable battery pack to the lamp, as well as to regulate the on/off status of the lamp, according to the existence or lack of external ambient light. A solar panel is mounted to the top surface of the two-piece assembly's upper housing and delivers electrical energy to recharge the rechargeable battery pack during periods where external ambient light exists, such as during the day, when directed to do so by the electronic circuit board.

The electronic circuit board, along with the rechargeable battery pack and lamp is located in the two-piece assembly's upper housing. The purpose of the upper housing is to accommodate the electrical components of the internal mailbox illumination system. The purpose of the lower base is to geometrically mate with the upper housing in the two-piece assembly system, while uniquely conforming to the geometric contour, profile, shape, and size of the mailbox to which the two-piece assembly is mounted. The lower base in secured to the top outer surface of the mailbox, and the top housing is in turn secured to the lower base by various means, with both interfaces forming a water and moisture-resistant seal.

In one aspect, disclosed is an illumination system comprising an upper housing comprising therein, an illumination system including an illumination source, a rechargeable battery pack comprising a compartment configured to accept one or more rechargeable batteries, at least one rechargeable battery disposed in the compartment and operatively connected to deliver electrical power to the illumination source, a solar panel, an electrical circuit electrically connected to said solar panel and the at least one rechargeable battery, said electrical circuit directing electrical energy created by said solar panel to said rechargeable battery pack when there is sufficient light falling on said solar panel to produce enough electrical energy to charge the battery, and optionally directing electrical energy stored in said at least one rechargeable battery to said illumination source when there is insufficient ambient light for said solar panel to produce electrical energy to charge the battery, and a lower base comprising an opening through which the illumination source or light emitted therefrom can pass, the lower base being configured for receiving said upper housing and concurrently providing a customizable interface that can be attached to an exterior surface, wherein the upper housing is operatively connected to the lower base.

### BRIEF DESCRIPTION OF THE DRAWINGS

The present disclosure is detailed through various drawings, where like components or steps are indicated by identical reference numbers for clarity and consistency.

FIG. 1 is an isometric view of a mailbox and an illumination device disposed on a top portion thereon in accordance with one aspect of the present disclosure.

FIG. 2 is an isometric view of the illumination device of FIG. 1 in continuing accordance with the aspect of the present disclosure.

FIG. 3 is a bottom perspective view of the illumination device of FIG. 1 in accordance with another aspect of the present disclosure.

FIG. 4 is a partial cutaway view of the illumination device of FIG. 1 in accordance with yet another aspect of the present disclosure.

FIG. 5 is an exploded view of the illumination device of FIG. 1 in accordance with another aspect of the present disclosure.

FIG. 6 is a frontal perspective view of a functioning illumination device in accordance with another aspect of the instant application.

FIG. 7 is a side cross-sectional view of the functioning illumination device of FIG. 6 in continuing accordance with the present disclosure.

FIG. 8 is a side elevational view of a customizable interface, in accordance to one embodiment of the present invention.

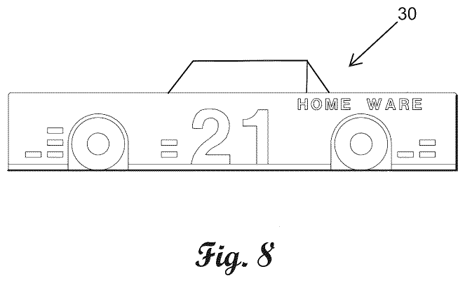

### DETAILED DESCRIPTION OF THE DISCLOSURE

The present disclosure generally relates to a system for illuminating the contents of an outdoor mailbox. Various inventions have been presented with the intent of providing internal illumination to a mailbox or similar enclosure, incorporating elements such as a lamp, a power source for the lamp, and a means to turn the energy being delivered to the lamp on and off. By the nature of the complexity of the suggested solutions, significant modifications must be made to the subject mailbox in order to implement them. In many cases these required modifications preclude implementation as a mailbox accessory as they necessitate a unique, non-standard mailbox design that is not compliant with U.S. Postal Service guidelines (reference USPS STD 7B and its successors). In other cases, although presented as a potential accessory, the inferred requirement for significant physical modification to the subject mailbox would effectively render the mailbox unusable should there be a need to remove the invention.

The present disclosure provides an enclosure illumination system that constitutes a self-contained, fully automated illumination source for the interior of a rural (curbside) mailbox. Moreover, the illumination system of the present disclosure integrates an interior illumination source that is actuated only in the absence of sufficient external ambient light as detected by the system. In addition, the illumination system of the present disclosure is easily and quickly adaptable to variances in rural mailbox shapes, profiles, contours and sizes and is substantially water-resistant.

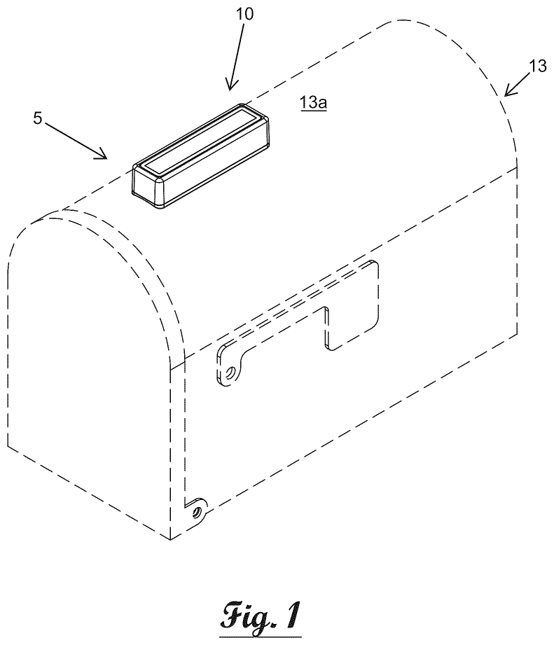

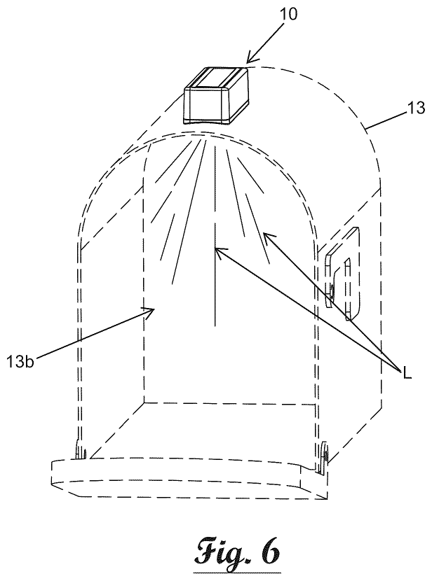

Certain embodiments of the assembly of the present disclosure will now be described in conjunction with the drawings that illustrate certain features. Turning to the drawings, FIGS. 1 and 6 show a mailbox 13 constructed in accordance with US Postal Service guidelines with an illumination system 10 according to the present disclosure affixed thereto. The mailbox 13 and illumination system 10 affixed thereto for a mailbox assembly 5 according to the present disclosure.

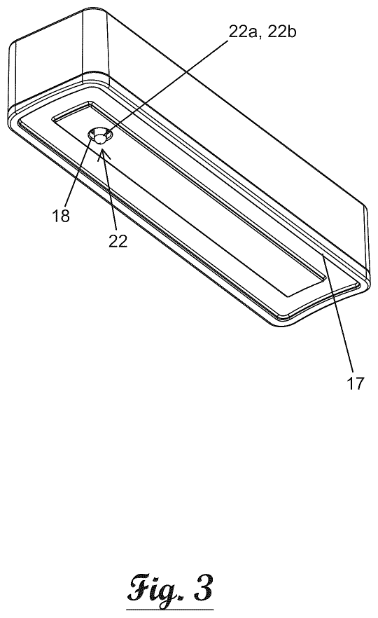

As further seen in FIGS. 1-3, a two-piece illumination system 10, which includes an upper housing 11 and a lower base 12 that can be produced in a variety of different embodiments to conform closely to the contour(s) of the top surface 13a of a mailbox 13, regardless of the mailbox's shape, profile, or size.

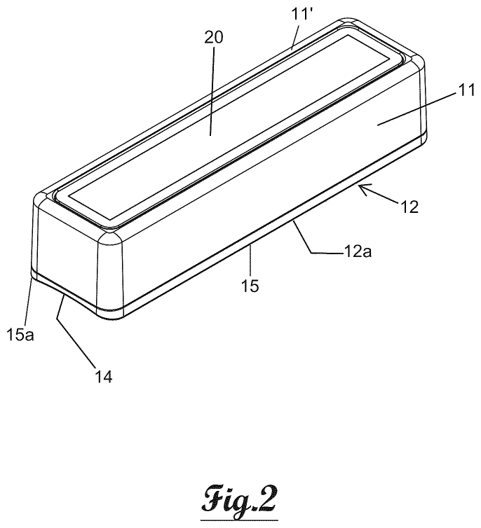

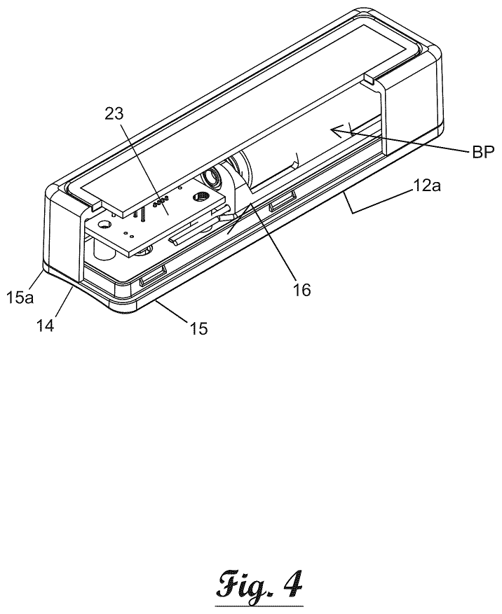

The lower base 12 of the illumination system 10 features a bottom surface 12a that can be contoured to match the shape, profile, contour and size of a specific mailbox design, as shown in FIGS. 2 and 4, wherein the bottom surface 12a comprises a curved surface 14 and opposing hybrid straight longitudinal side edges 15 and 15a. Regardless of the external interfacing surface, the internal surface 16 of the lower base 12 is flat, and perpendicular to the top surface of the mailbox when the two-piece illumination system 10 is installed.

In any embodiment, an adhesive material layer 17 may be placed between the bottom external surface 12a (facing the mailbox 13) of the lower base 12 and the top surface 13a of the mailbox 13 to secure the lower base 12 to the mailbox 13. Alternatively, the lower base 12 may be secured to the top surface 13a of the mailbox 13 using other fastening means (e.g., a screw, a rivet, a bolt, a magnetic interlock, a hoop and loop fastening system or interface, etc.) known in the art.

A hole 18 is located within the flat inner surface 16 of the lower base 12 to receive an illumination source (e.g., a lamp 22a) that resides within, and protrudes downwardly from, the upper housing 11. In accordance to one embodiment, the lamp 22a comprises a light emitting diode (LED) 22b.

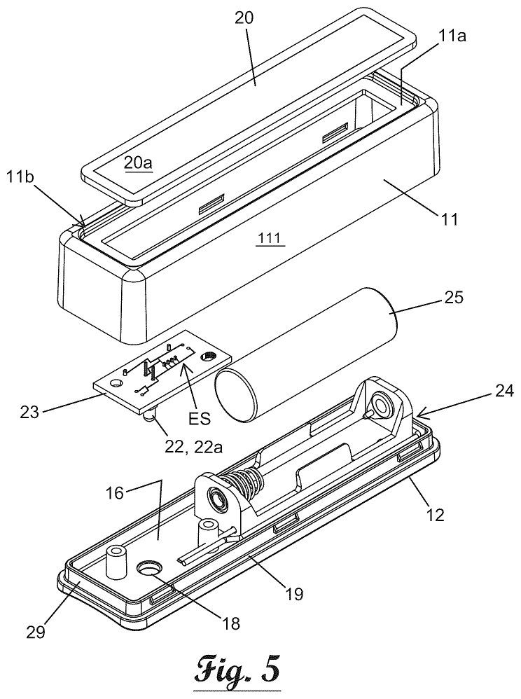

Referring now more particularly to FIG. 5, around the perimeter of the lower base 12, a recessed feature 19 exists to receive a gasket 29 which, in turn, provides a water and moisture resistant seal and interface between the upper housing 11 and lower base 12 when the upper housing 11 and the lower base 12 are mated together to form the illumination system assembly 10. A fastening means, such as screws, can be utilized to provide a tight interface between the upper housing 11 and lower base 12.

In reference to FIGS. 2 and 5, the upper housing 11 includes a solar panel 20 that is mounted into a recessed shelf 11b formed in the upper housing 11, the recessed shelf 11b having an upper surface 11a. The solar panel 20 comprises one or more solar cells 20a. A perimeter of the solar panel 20 may include holes through which screws can be inserted to provide a secure attachment by the solar panel 20 to the upper housing 11 when the upper housing 11 and lower base 12 are joined to form the two-piece illumination system 10. It is envisioned the solar panel 20 may also be removably secured in the top surface of the upper housing 11 via a snap-fit arrangement, frictional-interferential fit, hook-and-loop fasteners, or other suitable attachment mechanism or fastening means.

FIG. 6 illustrates a frontal view and an interior 13b of a mailbox 13 depicting the lower base 12 of the illumination system assembly 10 mounted on the top surface 13a of the mailbox 13, and the lamp 22a of the illumination system 10 is shown emitting light L, thereby causing the interior 13b of the mailbox 13 to be illuminated.

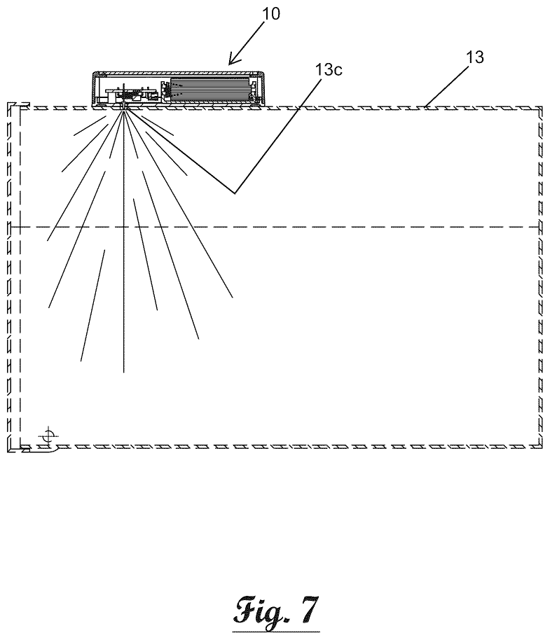

In reference to FIGS. 4-5, and 7, an electronic circuit board 23 having a power management and illumination circuit (electrical circuit ES) can also be seen in this view. The lamp 22a, electrically mounted to the electronic circuit board 23, is positioned directly above and received by the hole 18 in the lower base 12 such that it will extend through the bottom surface 12a of the lower base 12, through an aperture 13c defined through the top surface 13a of the mailbox 13, and into the interior 13b of the mailbox 13 when the two-piece illumination system assembly 10 is fully assembled.

Referring now more particularly to FIGS. 4 and 5, the internal components of the upper housing 11 are depicted. These components include an electronic circuit board 23, mounted internally to the upper housing 11; a solar panel 20 mounted to the upper surface 11a of the recessed shelf 11b of the upper housing 11, wherein the solar panel 20 is electrically connected to the electronic circuit board 23; a rechargeable battery pack BP comprising a compartment 24 designed to accept and retain at least one rechargeable battery 25, the rechargeable battery 25 is electrically connected to the electronic circuit board 23; and a lamp 22a that is electrically mounted to the electronic circuit board 23. It is envisioned the at least one rechargeable battery 25 is formulated from lead-acid, lithium ion, carbon based, nickel-cadmium or nickel metal hydride.

Internal illumination of the mailbox 13 is created by the lamp 22a, which receives its power from the rechargeable battery 25 through the electronic circuit board 23. During periods of light (when external ambient light exists) the solar panel 20 generates power and the electronic circuit board 23 directs that power to the rechargeable battery 25 to allow for re-charging. During periods of darkness (when ambient external light does not exist), the electronic circuit board 23 senses a lack of power generation within the solar panel 20 and directs the rechargeable battery 25 to deliver power to the lamp 22a. When the lamp 22a becomes energized from the electrical power, the lamp 22a provides illumination within the interior 13b of the mailbox 13 via the lamp 22a extending downwardly through the hole 18 in the lower base 12 and through the aperture 13c in the mailbox.

When the upper housing 11 is operatively connected to the lower base 12, an illumination source 22 (e.g., lamp 22a) is positioned so that the illumination source 22 extends through the hole 18 in the lower base 12 or is otherwise positioned so that light emitted from the illumination source 22 is directed through the hole 18.

FIGS. 5-7 show additional views of the illustrated embodiment of FIG. 4.

When the solar panel 20 is operatively connected to the upper housing 11, the solar panel 20 is electrically connected to the electronic circuit board 23, which is electrically connected to the rechargeable battery 25.

### Housing Components

The upper housing 11 and lower base 12 can be fabricated from a variety of materials (e.g., metal, plastic) using processes (e.g., injection molding) that are well known in the art. Gaskets (e.g., gasket 29) can be made of suitable moisture-resistant, conformable materials such as silicone polymers, or rubber, for example.

### Mailbox Assemblies

In another aspect, the present disclosure provides a mailbox assembly 5. The mailbox assembly 5 comprises a mailbox 13 with any one of the embodiments of the illumination systems 10 described herein mounted to the mailbox 13. In any embodiment of the mailbox assembly 5, the illumination system 10 is mounted on the mailbox 13 in a manner that forms a substantially water-resistant seal between the lower base 12 and the mailbox 13. In any of the above embodiments of the mailbox assemblies, the mailbox 13 comprises an aperture 13c or a hole, wherein the aperture 13c permits passage of light from the illumination source 22 into the interior 13b of the mailbox 13. In certain embodiments of the mailbox assembly 10, the aperture 13 c does not exceed 6 millimeters (mm) in diameter.

The present invention will now be described in conjunction with the FIGS. 1 and 2, wherein a mailbox 13 constructed in accordance with US Postal Service guidelines is depicted. As further seen in FIG. 1 and FIG. 2, a two-piece system 10, which includes an upper housing 11 and a lower base 12 that can be produced in a variety of different embodiments to match up against the top surface 13a of a mailbox 13, regardless of the shape, profile, contour or size of the mailbox 13. The lower base 12 features a bottom surface 12a that can be contoured to match the shape, profile, contour and size of a specific mailbox 13 design, as shown in FIG. 2 with a curved surface 14 and opposing hybrid straight longitudinal side edges 15 and 15a. Regardless of the external interfacing surface of the mailbox 13, the internal surface 16 of the lower base is flat, and perpendicular to the top surface 13a of the mailbox 13 when the two-piece assembly 10 is installed. In certain applications, an adhesive material layer 17 may be placed between the bottom external surface 12a of the lower base 12 and the top surface 13a of the mailbox 13 to secure the lower base 12 to the mailbox 13. Alternatively, the lower base 12 may be secured to the top surface 13a of the mailbox 13 using screws. A hole 18 is located within the flat inner surface 16 of the lower base 12 to receive the lamp 22a that resides within, and protrudes from, the upper housing 11. Around the perimeter of the lower base 12, a recessed feature 19 exists to receive a gasket 29, wherein the gasket 29 provides a water and moisture resistant seal and interface between the upper housing 11 and lower base 12 when the upper housing 11 and lower base 12 are mated together comprising the illumination system 10. Screws 28 can be utilized to provide a tight interface between the upper housing 11 and lower base 12. In some aspects, any component of the illumination system 10 listed herein can be configured to be secured together via a snap fit. For example, the upper housing 11 and lower base 12 can be detachably securable via a snap fit. As used herein, the term “snap fit” generally refers to a substantially resilient and elastomeric structure being configured to interlock while so engaged with each other. The upper housing 11 includes a solar panel 20 that is mounted into a recessed shelf 11b integrally depending from a top surface 11′ of the upper housing 11, the recessed shelf 11b having an upper surface 11a. A perimeter of the solar panel 20 may include holes through which screws can be inserted to provide a secure attachment by the solar panel 20 to the upper housing 11 when the upper housing 11 and lower base 12 are fixedly joined to form the two-piece illumination system assembly 10.

FIG. 6 illustrates a frontal view and interior of a mailbox 13 depicting the illumination system 10 mounted atop a mailbox 13. More particularly, the lower base 12 of the illumination system 10 is shown mounted superjacent the top surface 13a of the mailbox 13. As previously disclosed, an electronic circuit board 23 comprising a power management and illumination circuit is provided, as best depicted in FIG. 5. A lamp 22a, electrically mounted to the electronic circuit board 23, is positioned directly above the hole 18 in the lower base 12 such that it will extend through the bottom surface 12a of the lower base 12 and into the interior 13b of the mailbox 13 when the two-piece system 10 is assembled. FIGS. 4 and 5 illustrate the internal components of the upper housing 11. These components include an electronic circuit board 23 mounted internally to the upper housing 11; a solar panel 20 securably seated in the recessed shelf 11b of the upper housing 11, the solar panel 20 is electrically connected to the electronic circuit board 23; a compartment 24 designed, shaped, and configured to retain a rechargeable battery 25 being electrically connected to the electronic circuit board 23; and a lamp 22a electrically mounted to the electronic circuit board 23. Internal illumination of the mailbox 13 is created by the lamp 22a, wherein the lamp 22a receives power from the rechargeable battery 25 through the electronic circuit board 23. During periods of light (when external ambient light exists) the solar panel 20 generates power and the electronic circuit board 23 directs that power to the rechargeable battery 25 to allow for re-charging. During periods of darkness (when ambient external light does not exist), the electronic circuit board 23 senses a lack of power generation within the solar panel 20 and directs the rechargeable battery 25 to deliver power to the lamp 22a. When the lamp 22a becomes energized from the electrical power, the lamp 22a provides illumination within the interior 13b of the mailbox 13 through the hole 18 in the lower base 12.

### 3-D Components

One aspect of the present invention pertains to a feature on the upper housing 11 which can be configured to engage with a three-dimensional (“3D”) printed overlay. The overlay or customizable interface 30 is attached or detachably secured to an exterior surface 111 of the upper housing 11. The customizable interface 30 can be adapted to engage with the upper housing 11, for example, via a snap fit. Importantly, the feature is structed so as to not impede or substantially impede sunlight access to the solar panel 20. More particularly, the incorporation of such feature can function to provide customization of the illumination device 10, for example in the aftermarket. The feature can be an ornament or an article disposed with an ornamental design. By way of one example, the feature can be an ornamental design which can be snap fitted onto a portion of the mailbox 13 or any structure presented herein, wherein the feature is customized by the user and/or individualized. For example, envision an individual who has a fondness for racecars. This individual purchases a 3D printed racecar customizable interface 30 from an entrepreneur that snaps over the top of the illumination system 10 to add aesthetic and/or ornamental character to the mailbox 13. More generally, one aspect of the invention pertains to adding a feature for including a 3D printed customizable interface 30 to the upper housing 11 of the mailbox illumination system 10, thereby enhancing its functionality and appeal by providing a customizable aesthetic product while preserving the core functions of the system 10.

The upper housing 11 of the mailbox illumination system 10 can be designed with an integrated snap-fit feature to allow the attachment of a 3D printed customizable interface 30, enabling users to customize the exterior appearance of the upper housing 11 without compromising the functionality of the solar panel 20, as previously described herein. The upper housing 11 can include a series of grooves or retention clips (not shown) positioned along a perimeter of the upper housing 11, wherein the series of grooves are geometrically configured to engage corresponding tabs on the 3D customizable interface 30, allowing the 3D customizable interface 30 and the upper housing 11 to be fixedly joined in a snap-fit arrangement. The 3D customizable interface 30 may be designed with openings or transparent sections directly above the solar panel 20 to ensure unobstructed access to sunlight for optimal battery 25 charging. For example, a user could purchase a racecar-themed 3D customizable interface 30 from a third-party vendor. The racecar-themed 3D customizable interface 30 would be adapted and configured to snap over the upper housing 11, thereby adding a personalized aesthetic to their mailbox 13 while preserving the ability of the illumination system 10 to operate as intended. This design allows for easy customization and removal of the 3D customizable interface 30, providing flexibility for seasonal or stylistic changes without requiring tools.

In an alternative aspect, the upper housing 11 of the mailbox illumination system 10 can be designed to incorporate a snap-fit mechanism that allows for the secure attachment of a 3D printed customizable interface 30. This snap-fit feature consists of molded grooves or recesses along the perimeter of the upper housing 11, the molded grooves or recesses align with corresponding retention clips (not shown) suitably disposed on the 3D customizable interface 30. The 3D customizable interface 30 can be customized with a variety of ornamental designs, allowing users to personalize their mailbox 13 without compromising the functionality of the illumination system 10. For example, a user who enjoys racecars may purchase a 3D printed customizable interface 30 designed to resemble a racecar. The 3d printed racecar customizable interface 30 easily snaps onto the upper housing 11, covering the illumination system 10 while leaving the solar panel 20 unobstructed for optimal energy absorption. The snap-fit feature ensures the 3D customizable interface 30 is securely attached and weather-resistant, while also allowing for quick removal and replacement as desired by the user.

### Conclusion

As used herein, including in the claims, the phrases “at least one of” or “one or more of” a list of items refer to any combination of those items, including single members. For example, “at least one of: A, B, or C” covers the possibilities of: A only, B only, C only, a combination of A and B, a combination of A and C, a combination of B and C, and a combination of A, B, and C. Additionally, the terms “comprise,” “comprises,” “comprising,” “include,” “includes,” and “including” are intended to be non-limiting and open-ended. These terms specify essential elements or steps but do not exclude additional elements or steps, even when a claim or series of claims includes more than one of these terms.

While the present disclosure has been detailed and depicted through specific embodiments and examples, it is to be understood by those skilled in the art that numerous variations and modifications can perform equivalent functions or yield comparable results. Such alternative embodiments and variations, which may not be explicitly mentioned but achieve the objectives and adhere to the principles disclosed herein, fall within its spirit and scope. Accordingly, they are envisioned and encompassed by this disclosure, warranting protection under the claims associated herewith. That is, the present disclosure anticipates combinations and permutations of the described elements, operations, steps, methods, processes, algorithms, functions, techniques, modules, circuits, etc., in any manner conceivable, whether collectively, in subsets, or individually, further broadening the ambit of potential embodiments.

Although operations, steps, instructions, and the like are shown in the drawings in a particular order, this does not imply that they must be performed in that specific sequence or that all depicted operations are necessary to achieve desirable results. The drawings may schematically represent example processes as flowcharts or flow diagrams, but additional operations not depicted can be incorporated. For instance, extra operations can occur before, after, simultaneously with, or between any of the illustrated steps. In some cases, multitasking and parallel processing might be beneficial. Furthermore, the separation of system components described should not be interpreted as mandatory for all implementations, as the program components and systems can be integrated into a single software product or distributed across multiple software products.

As used throughout, the singular forms “a,” “an,” and “the” include plural referents unless the context clearly dictates otherwise. Thus, for example, reference to a quantity of one of a particular element can comprise two or more such elements unless the context indicates otherwise. In addition, any of the elements described herein can be a first such element, a second such element, and so forth (e.g., a first widget and a second widget, even if only a “widget” is referenced).

Ranges can be expressed herein as from “about” one particular value and/or to “about” another particular value. When such a range is expressed, another aspect comprises from the one particular value and/or to the other particular value. Similarly, when values are expressed as approximations, by use of the antecedent “about” or “substantially,” it will be understood that the particular value forms another aspect. It will be further understood that the endpoints of each of the ranges are significant both in relation to the other endpoint and independently of the other endpoint.

For purposes of the current disclosure, a material property or dimension measuring about X or substantially X on a particular measurement scale measures within a range between X plus an industry-standard upper tolerance for the specified measurement and X minus an industry-standard lower tolerance for the specified measurement. Because tolerances can vary between different materials, processes, and between different models, the tolerance for a particular measurement of a particular component can fall within a range of tolerances.

As used herein, the terms “optional” or “optionally” mean that the subsequently described event or circumstance may or may not occur, and that the description comprises instances where said event or circumstance occurs and instances where it does not.

What is claimed is:

1. An illumination system comprising:
an upper housing, the upper housing comprising:
an illumination source;
a rechargeable battery pack comprising a compartment configured to retain at least one rechargeable battery;
at least one rechargeable battery disposed in the compartment and operatively connected to the illumination source to deliver electrical power to the illumination source;
a solar panel;
an electronic circuit board electrically connected to the solar panel and the at least one rechargeable battery, the electronic circuit board directing electrical energy created by the solar panel to the rechargeable battery pack when there is sufficient light falling on said solar panel to produce enough electrical energy to charge the at least one rechargeable battery, and directing electrical energy stored in the at least one rechargeable battery to the illumination source when there is insufficient ambient light for said solar panel to produce electrical energy to charge the battery; and
a lower base comprising an opening through which the illumination source downwardly protrudes, the illumination source emits light therefrom, and wherein the upper housing is operatively connected to the lower base.

2. The illumination system of claim 1, wherein the illumination source is configured to illuminate an interior of a mailbox.

3. The illumination system of claim 1, further comprising a first interface that tightly mates the lower base to the mailbox.

4. The illumination system of claim 3, further comprising a second interface that mates the upper housing to the lower base.

5. The illumination system of claim 4, wherein the upper housing is securably joined to the lower base in a manner so as to provide a moisture resistant seal.

6. The illumination system of claim 3, wherein the lower base is adapted to conform closely to a contour of a top surface of the mailbox.

7. The illumination system of claim 1, wherein the solar panel comprises one or more solar cells.

8. The illumination system of claim 1, wherein the electronic circuit board includes an electrical circuit residing thereon or therein.

9. The illumination system of claim 2, wherein the illumination source is a light emitting diode.

10. The illumination system of claim 9, wherein the light emitting diode is electrically connected to the electronic circuit board.

11. The illumination system of claim 1, wherein the at least one rechargeable battery is formulated from lead-acid, lithium ion, carbon based, nickel-cadmium or nickel metal hydride.

12. The illumination system of claim 1, wherein the rechargeable battery pack receives electrical energy created by the solar panel when there is sufficient external ambient light enabling the solar panel to produce enough electrical energy to charge the at least one rechargeable battery.

13. The illumination system of claim 2, wherein the illumination source receives electrical energy from the rechargeable battery pack when there is insufficient external ambient light for the solar panel to produce enough electrical energy to charge the at least one rechargeable battery.

14. An illumination system comprising:
an upper housing, the upper housing comprising:
an illumination source;
a rechargeable battery pack comprising a compartment configured to retain at least one rechargeable battery;
at least one rechargeable battery disposed in the compartment and operatively connected to the illumination source to deliver electrical power to the illumination source;
a solar panel;
an electronic circuit board electrically connected to the solar panel and the at least one rechargeable battery, the electronic circuit board directing electrical energy created by the solar panel to the rechargeable battery pack when there is sufficient light falling on said solar panel to produce enough electrical energy to charge the at least one rechargeable battery, and directing electrical energy stored in the at least one rechargeable battery to the illumination source when there is insufficient ambient light for said solar panel to produce electrical energy to charge the battery;
a lower base comprising an opening through which the illumination source downwardly protrudes, the illumination source emits light therefrom, wherein the upper housing is operatively connected securely to the lower base; and
a customizable interface attached to an exterior surface of the upper housing.

15. An illumination assembly comprising:
a mailbox and an illumination system.

16. The assembly of claim 15, wherein the illumination system comprises:
an upper housing, the upper housing comprising:
an illumination source;
a rechargeable battery pack comprising a compartment configured to retain at least one rechargeable battery;
at least one rechargeable battery disposed in the compartment and operatively connected to the illumination source to deliver electrical power to the illumination source;
a solar panel;
an electronic circuit board electrically connected to the solar panel and the at least one rechargeable battery, the electronic circuit board directing electrical energy created by the solar panel to the rechargeable battery pack when there is sufficient light falling on said solar panel to produce enough electrical energy to charge the at least one rechargeable battery, and directing electrical energy stored in the at least one rechargeable battery to the illumination source when there is insufficient ambient light for said solar panel to produce electrical energy to charge the battery; and
a lower base comprising an opening through which the illumination source downwardly extends, the illumination source emits light therefrom, and wherein the upper housing is operatively connected to the lower base.

17. The assembly of claim 16, wherein the illumination system is mounted on the mailbox in a manner that forms a substantially water-resistant seal between the lower base and the mailbox.

18. The assembly of claim 17, further comprising a customizable interface attached to an exterior surface of the upper housing.
